(19) United States
(12) Patent Application Publication
(10) Pub. No.: US 2018/0354174 A1
(43) Pub. Date: Dec. 13, 2018

(54) NOZZLE ASSEMBLY

(71) Applicant: MOLD-MASTERS (2007) LIMITED, Georgetown (CA)

(72) Inventor: Jiping QIAN, Mississauga (CA)

(21) Appl. No.: 16/003,942

(22) Filed: Jun. 8, 2018

Related U.S. Application Data
(60) Provisional application No. 62/517,555, filed on Jun. 9, 2017.

(51) Int. Cl. B29C 45/20

(52) U.S. Cl. CPC B29C 45/20

(57) ABSTRACT

A nozzle assembly is provided. The nozzle assembly comprising: a nozzle defining a bore; a tip and a tip retainer housed in the downstream portion of the bore of the nozzle, the tip including a flange threadably connected to the downstream portion of the bore of the nozzle, and the tip retainer threadably connected to the downstream portion of the bore of the nozzle, the tip retainer having an upstream surface abutting a downstream surface of the flange.

### FIELD

The invention relates generally to a nozzle assembly for use in an injection molding apparatus and, in particular, to a nozzle assembly having a tip threadably connected to a nozzle.

### BACKGROUND

Injection molding heats a material (e.g., plastic) into a melt, injects the melt into a cavity of a mold, and, after the melt cools and forms a solid article in the cavity, ejects the article from the cavity. Typically, an injection molding apparatus comprises a feed screw and a heated melt delivery body including a hot runner, a plurality of nozzles attached downstream to the hot runner, and a mold having a plurality of cavities corresponding to the respective nozzles. The feed screw injects the melt into the hot runner. The hot runner distributes the melt from a single stream to multiple cavities via the respective nozzles. Because of the high pressure of the melt, there are challenges to reduce the risk of various components of the heated melt delivery body from disassembling by the melt pressure while the injection molding apparatus is in operation.

### SUMMARY

An aspect of the present application provides a nozzle assembly comprising: a nozzle defining a bore having an upstream portion and a downstream portion; a tip and a tip retainer housed in the downstream portion of the bore of the nozzle, the tip defining a bore having an upstream portion and a downstream portion, the bore of the tip and the upstream portion of the bore of the nozzle forming a melt passage for conveying melt from a source to a cavity, the tip including an outlet in fluid communication with the bore of the tip for dispensing the melt into the cavity, the tip including a flange threadably connected to the downstream portion of the bore of the nozzle, the flange between the upstream and downstream portions of the tip, the flange having a diameter greater than a diameter of the upstream portion of the tip and a diameter of the downstream portion of the tip, the tip retainer threadably connected to the downstream portion of the bore of the nozzle, the tip retainer having an upstream surface abutting a downstream surface of the flange.

### BRIEF DESCRIPTION OF THE DRAWINGS

The foregoing and other features and advantages of the invention will be apparent from the following description of embodiments hereof as illustrated in the accompanying drawings. The accompanying drawings, which are incorporated herein and form a part of the specification, further serve to explain the principles of the invention and to enable a person skilled in the pertinent art to make and use the invention. The drawings are not to scale

FIG. 1 is a sectional view of a nozzle assembly, according to an embodiment of the present application.

FIG. 2 is an enlarged view of area A of the nozzle assembly of FIG. 1.

FIG. 3 is perspective view of a tip of FIG. 1, according to an embodiment of the present application.

FIG. 4 is perspective view of a tip retainer of FIG. 1, according to an embodiment of the present application.

### DETAILED DESCRIPTION

In the description, “downstream” is used with reference to the direction of the moldable liquid flow from an injector to a mold cavity, and also with reference to the order of components, or features thereof, through which the mold material flows from the injector to the mold cavity, whereas “upstream” is used with reference to the opposite direction.

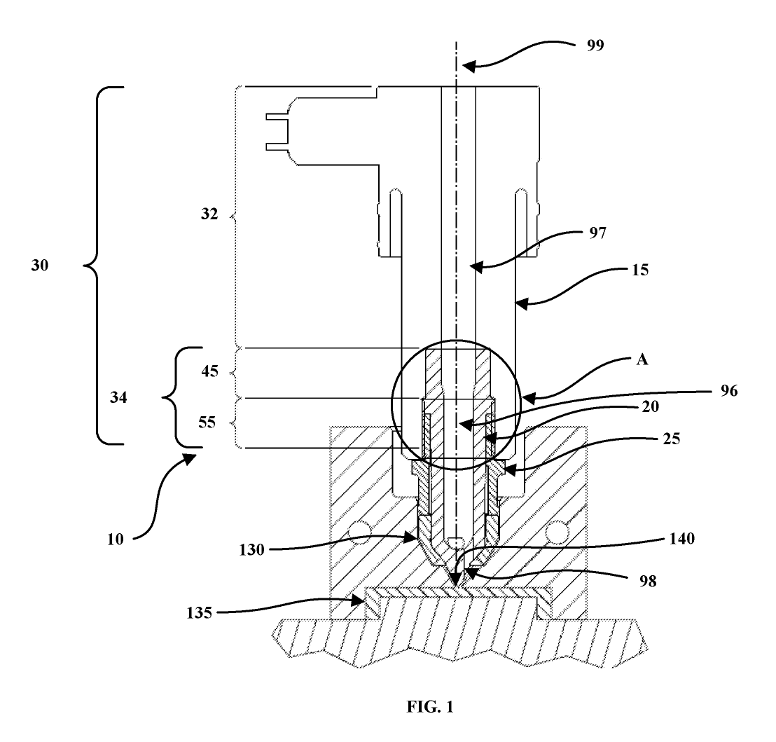

FIG. 1 is an illustrated embodiment of a nozzle assembly 10 of the present application. Nozzle assembly 10 comprises a nozzle 15, a tip 20 and a tip retainer 25, both threadably connected to nozzle 15. Nozzle 15 defines a bore 30 for passing a melt through nozzle 15 and for connecting to tip 20 and tip retainer 25. Bore 30 includes an upstream portion 32 and a downstream portion 34.

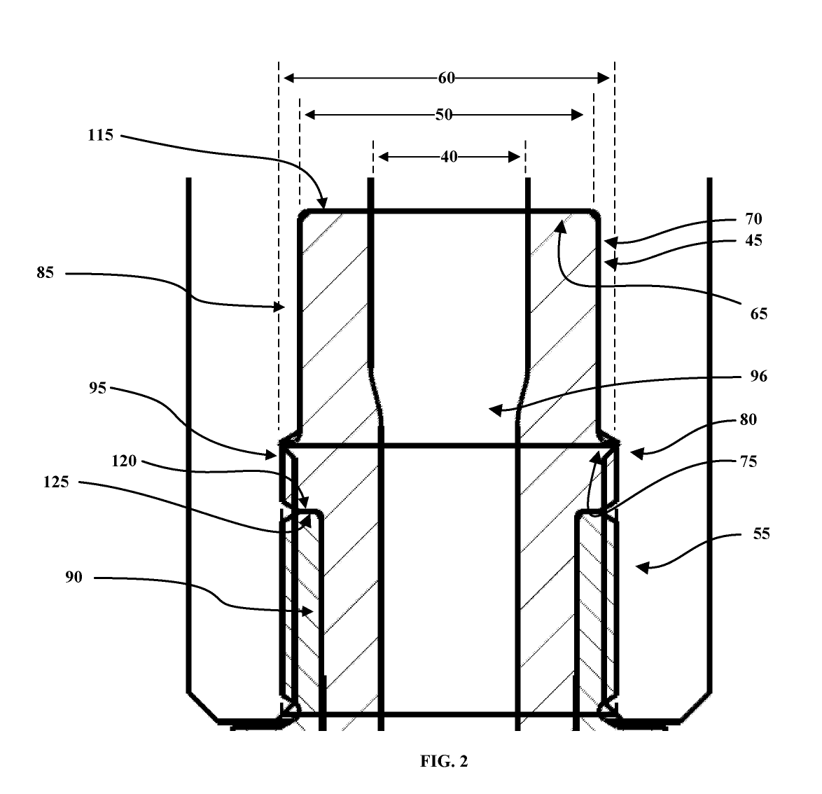

Referring to FIG. 2, which is an enlarged view of area A of FIG. 1, upstream portion 32 (also referred to as first portion 32) includes a first diameter 40. Downstream portion 34 includes a second portion 45 having a second diameter 50, and a third portion 55 having a third diameter 60. First portion 32 is upstream of second portion 45. Second portion 45 is upstream of third portion 55. Bore 30 includes a first shoulder 65 at a first upstream end 70 of second portion 45 and a second shoulder 75 at a second upstream end 80 of third portion 55. In the illustrated embodiments, shoulder 75 is angled relative to bore 30. First diameter 40 is less than second diameter 50. Second diameter 50 is less than third diameter 60.

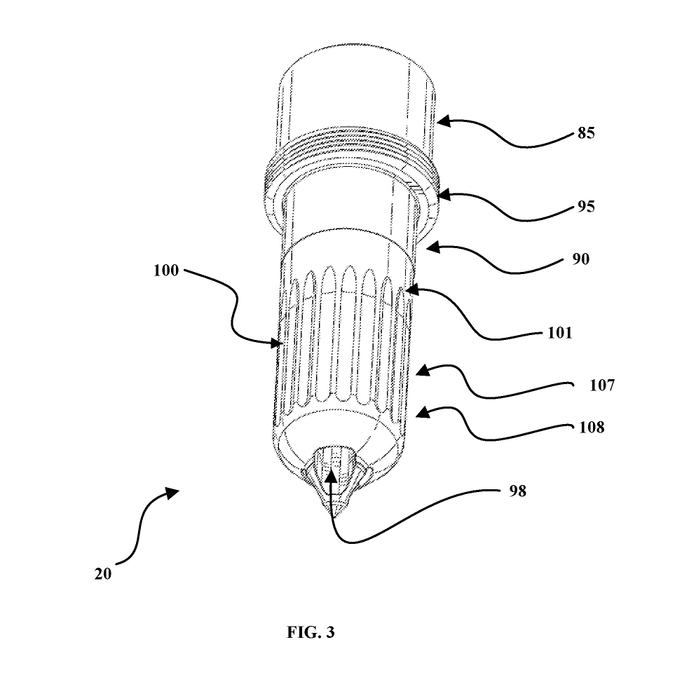

Referring to FIG. 3, tip 20 includes an upstream portion 85, a downstream portion 90 and externally threaded flange 95 separating upstream portion 85 and downstream portion 90. Flange 95 has a diameter greater than the diameter of upstream portion 85 and downstream portion 90. Downstream portion 90 is downstream of upstream portion 85. Tip 20 defines a bore 96 and when tip 20 is assembled in nozzle 15, bore 96 forms part of a melt passage 97 with part of bore 30 for delivering a melt through nozzle assembly 10 (i.e., bore 96 and upstream portion 32 together forms melt passage 97 for conveying the melt from a source (not shown) to a cavity 135) (see FIG. 1). Bore 96 includes at least one outlet 98 radially offset from a center 99 of bore 96 for dispensing the melt from melt passage 97 to a respective cavity 135 (see FIG. 1). Tip 20 includes a fourth portion 107 at a downstream end 108 of tip 20 having a plurality of longitudinal grooves 100 on a circumferential surface 101 to provide a gripping surface for a tool to facilitate gripping of tip 20 during assembling of tip 20 to nozzle 15 and disassembling of tip 20 from nozzle 15.

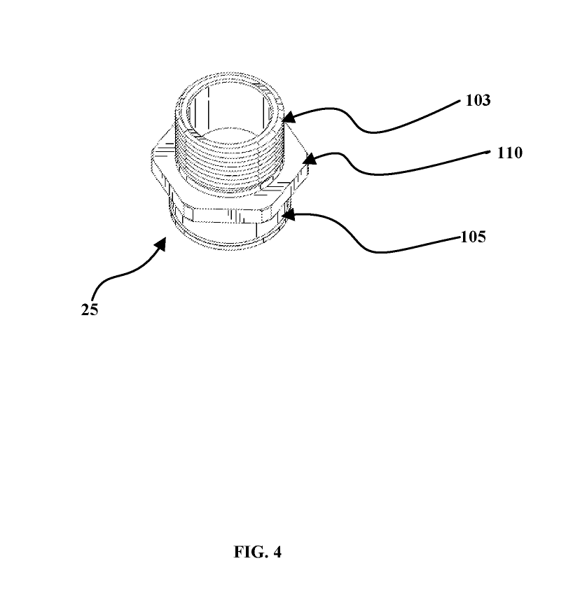

Referring to FIG. 4, tip retainer 25 includes a fifth portion 103 that is externally threaded, a sixth portion 105, and a flange 110 separating fifth portion 103 from sixth portion 105. Sixth portion 105 is downstream of flange 110.

Assembling nozzle assembly 10 comprises: threadably connecting tip 20 to third portion 55 by threadably connecting threaded flange 95 to third portion 55 until an upstream surface 115 of tip 20 engages first shoulder 65 at a sufficient tightness; and threadably connecting tip retainer 25 to third portion 55 by threadably connecting fifth portion 103 to third portion 55 until an upstream surface 120 of tip retainer 25 is sufficiently tight against a downstream surface 125 of flange 95 to reduce the risk of flange 95 self-loosening from third portion 55 or the melt leaking, due to the pressure of the melt passing through melt passage 97, through the interfaces between tip 20, tip retainer 25, and nozzle 20. At least a portion of upstream portion 85 is in sliding fit with second portion 45 to help align tip 20 with a gate 140 of cavity 135.

In the illustrated embodiment a nozzle well insert 130 is included (see FIG. 1).

While various embodiments according to the present application have been described above, it should be understood that they have been presented by way of illustration and example only, and not limitation. It will be apparent to persons of ordinary relevant skill in the relevant art that various changes in form and detail can be made therein without departing from the scope of the invention. It will also be understood that each feature of each embodiment discussed herein, may be used in combination with the features of any other embodiment. Thus, the breadth and scope of the present invention should not be limited by the above-described exemplary embodiments, but should be defined only in accordance with the appended claims and their equivalents.

What is claimed is:

1. A nozzle assembly comprising:
a nozzle defining a bore having an upstream portion and a downstream portion; and
a tip and a tip retainer housed in the downstream portion of the bore of the nozzle,
the tip defining a bore having an upstream portion and a downstream portion, the bore of the tip and the upstream portion of the bore of the nozzle forming a melt passage for conveying melt from a source to a cavity,
the tip including an outlet in fluid communication with the bore of the tip for dispensing the melt into the cavity,
the tip including a flange threadably connected to the downstream portion of the bore of the nozzle, the flange between the upstream and downstream portions of the tip, the flange having a diameter greater than a diameter of the upstream portion of the tip and a diameter of the downstream portion of the tip, and
the tip retainer threadably connected to the downstream portion of the bore of the nozzle, the tip retainer having an upstream surface abutting a downstream surface of the flange.

2. The nozzle assembly of claim 1, wherein a portion of the upstream portion of the tip is in sliding fit with the downstream portion of the bore of the nozzle.

3. The nozzle assembly of claim 2, wherein the upstream portion of the tip is in sliding fit with the downstream portion of the bore of the nozzle.

4. The nozzle assembly of claim 1, wherein the tip includes a plurality of longitudinal grooves on an external surface of the downstream portion of the tip to facilitate gripping of the tip for assembly of the tip to the nozzle or disassembly of the tip from the nozzle.
